(19) United States
(12) Patent Application Publication
(10) Pub. No.: US 2024/0100619 A1
(43) Pub. Date: Mar. 28, 2024

(54) FASTENER APPARATUS, FASTENER ATTACHING DEVICE USING THE FASTENER APPARATUS, AND FASTENER ATTACHING METHOD USING THE FASTENER ATTACHING DEVICE

(71) Applicant: SUBARU CORPORATION, Tokyo (JP)

(72) Inventor: Noboru SAKAMOTO, Tokyo (JP)

(21) Appl. No.: 18/368,460

(22) Filed: Sep. 14, 2023

(30) Foreign Application Priority Data
Sep. 27, 2022 (JP) 2022-153756

(51) Int. Cl. B23K 11/00; B23K 37/02

(52) U.S. Cl. CPC B23K 11/0053; B23K 37/0229

(57) ABSTRACT

A fastener apparatus is to be welded to a workpiece by a fastener attaching device. The fastener apparatus includes fasteners oriented in a same direction and joined together via a separable fragile portion to form a rod body.

### CROSS-REFERENCE TO RELATED APPLICATIONS

The present application claims priority from Japanese Patent Application No. 2022-153756 filed on Sep. 27, 2022, the entire contents of which are hereby incorporated by reference.

### BACKGROUND

The disclosure relates to a fastener to be attached to a workpiece by an attaching device provided on an arm, such as a manipulator, of a robot; a fastener attaching device using the fastener; and a fastener attaching method using the fastener attaching device.

For example, as described in Japanese Unexamined Patent Application Publication (JP-A) No. 2020-89903, a stud welder is used as an attaching device for attaching, by arc welding, a stud bolt, serving as a fastener, to a workpiece, such as a steel member, in the production of vehicle bodies of mass-produced vehicles. The stud welder disclosed in JP-A No. 2020-89903 is called a welding gun, with which a stud bolt gripped by a gripper, called a collet, provided at the end of the welding gun is manually welded to a workpiece. With such a manual welding gun, welding is performed after gripping the stud bolt with the gripper one-by-one.

In the mass production of vehicle bodies, such a stud welder is attached to a manipulator (also called an arm) of an industrial robot, and stud bolts are successively welded to a vehicle body member, which is a workpiece. For example, a stud bolt in a specified posture held by a gripper (specified position) in the stud welder is pushed out toward the workpiece to be welded. Hence, in the stud welder used in the mass production of vehicle bodies, stud bolts, serving as fasteners, in a predetermined posture are successively delivered to a specified position in the stud welder.

In the stud welder used in the mass production of vehicle bodies, fasteners in a specified posture are delivered to a specified position in the device by pressurized air. In this fastener delivery device, for example, fasteners are fed one-by-one by a parts feeder and delivered in a predetermined posture into a tubular body, such as a hose, coupled to the stud welder. Pressurized air is supplied to this tubular body. The fasteners in a predetermined posture fed by this pressurized air is pressure-conveyed to the stud welder and gripped by a gripper (collet) provided in the stud welder. Then, an electrode rod provided in the stud welder pushes out the fastener gripped by the gripper toward the workpiece to bring an opposing fixed electrode (workpiece) and the fastener into contact with each other, and raises the fastener, while allowing a current to flow between the electrodes, to generate an arc. When the fastener is pressed again against the portion melted by the arc, the fastener is fixed to the workpiece.

### SUMMARY

An aspect of the disclosure provides a fastener apparatus to be welded to a workpiece by a fastener attaching device. The fastener apparatus includes fasteners oriented in a same direction and joined together via a separable fragile portion to form a rod body.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a plan view of a rod body formed of fasteners joined together in a rod shape, according to an embodiment of the disclosure;

FIG. 2 is a side view of a fastener attaching device (welding gun) according to the embodiment of the disclosure;

FIG. 3A is a plan view of a device for supplying rod bodies to be loaded into the fastener attaching device, according to the embodiment of the disclosure;

FIG. 3B schematically illustrates the configuration of a mechanism for loading the rod bodies into the fastener attaching device, according to the embodiment of the disclosure;

FIG. 3C is a partially enlarged view of FIG. 3B;

FIG. 4 is a cross-sectional view of a mechanism for loading the rod bodies into the fastener attaching device, according to an embodiment of the disclosure;

FIG. 5A schematically illustrates the configuration of a feeder for sequentially feeding the rod body, according to the embodiment of the disclosure;

FIG. 5B is an enlarged view of the feeder;

FIG. 6 schematically illustrates a method of exposing a next fastener from a clamping member (collet), according to the embodiment of the disclosure;

FIG. 7 schematically illustrates a method of cutting the fastener after the rod body is welded, according to the embodiment of the disclosure; and

FIG. 8 schematically illustrates a method of fuse-cutting the fastener after the rod body is welded, according to an embodiment of the disclosure.

### DETAILED DESCRIPTION

In the mass production of vehicle bodies or the like, a stud welder is attached to a manipulator of an industrial robot, and, usually, a tubular body extending from a fastener delivery device is coupled to the stud welder. Hence, the tubular body for supplying fasteners is dragged around as the manipulator moves. At this time, the tubular body may be bent or twisted, causing a delivery failure, such as jamming of fasteners. In addition, there may be the cases where a plating material peeling off the fastener, such as a stud bolt, is deposited inside the tubular body and where the manipulator of the robot takes different postures depending on the welding part when multiple parts are to be welded. In such cases, the dragged tubular body takes various forms, and the frictional resistance in the tubular body at the time of fastener deliver changes each time. As a result, a fastener delivery failure may occur, or the dragged tubular body may inhibit the manipulator of the robot, i.e., the stud welder, from moving to a desired position or taking a desired posture. Such a situation interrupts the stud welding operation, thus lowering the working rate. This has been a problem in the conventional stud welding equipment.

It is desirable to provide a fastener, a fastener attaching method, and a fastener attaching device with which the fastener can be attached to a workpiece without any trouble in the fastener attaching operation.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

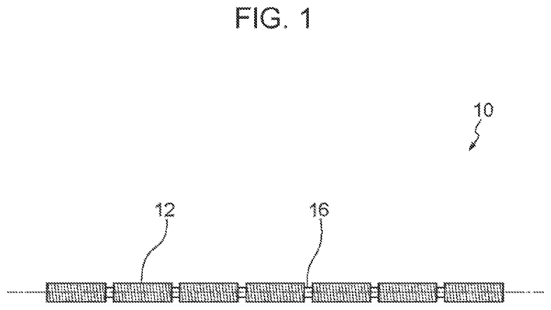

FIG. 1 illustrates the configuration of a rod body. In one embodiment, the rod body may serve as a “fastener”. As illustrated in FIG. 1, for example, about 10 to 20 fasteners 12 are joined together to form a rod body 10. That is, unlike the fasteners each formed as a single component, the rod body 10 according to this embodiment is formed of multiple fasteners 12 joined together via fragile portions 16.

The fastener 12 at the end of the rod body 10 welded to the workpiece and the remaining portion of the rod body 10 are separated at the fragile portion 16 therebetween. Although the fragile portions 16 are small-diameter portions (constriction) in this embodiment, the fragile portions 16 may have any structure as long as the fragile portions 16 are more easily separated than the portions constituting the fasteners 12 when a force in the separating direction is applied thereto. For example, the fragile portions 16 may be formed by providing V-shaped grooves in the outer circumferential surface of the rod body 10, or the fragile portions 16 may be formed of a material having a lower strength than the fasteners 12. Alternatively, it is possible to make the fragile portions 16 easy to be cut by making the fragile portions 16 have a porous structure using the same material as the fastener 12. With this structure, when a fragile portion 16 is fuse-cut by supplying a current as will be described below, the fragile portion 16 can be easily fuse-cut by heat generated by the current because the porous portion has a low density, and thus has a low strength, and a high electric resistance.

When the rod body 10 is accommodated or loaded in a fastener attaching device described below, multiple fasteners 12 are ready in the fastener attaching device. Hence, welding of the fasteners 12 is performed as a series of operations performed by the number of the fasteners 12 joined together. In other words, a series of attaching operations is possible without needing to deliver the fasteners 12 to the fastener attaching device. Because the individual fasteners 12 are oriented in the same direction and joined together, when the rod body 10 is loaded or accommodated in the fastener attaching device, the fasteners 12 are in a posture ready to be attached.

Next, the structure of the fastener attaching device using the rod body 10 according to the embodiment of the disclosure will be described in detail with reference to the drawings.

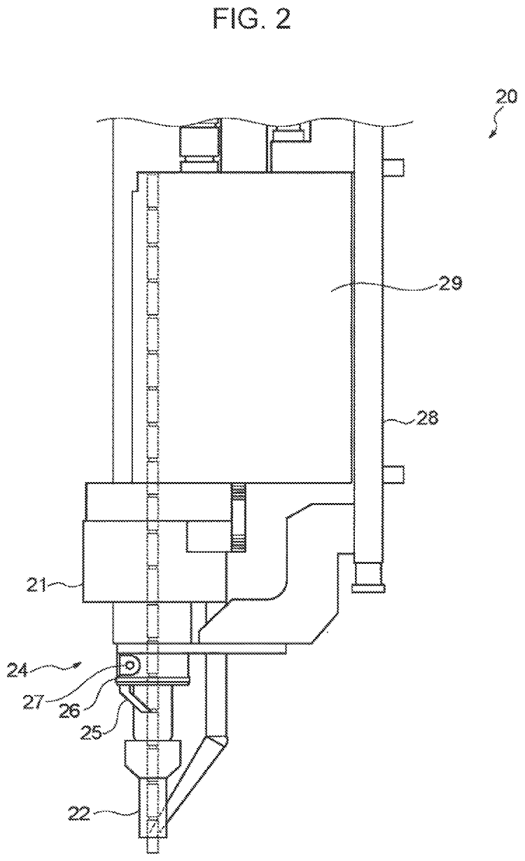

FIG. 2 is a side view of a fastener attaching device 20 according to an embodiment of the disclosure. In this embodiment, an example in which a welding gun is used as the fastener attaching device will be described. The welding gun 20 is fixed to a working end of a manipulator of a robot (not illustrated) via a robot manipulator mount 29. A rod body holder 21 for accommodating and holding the rod body 10, serving as the fastener, is provided at the end of the welding gun 20, and a clamping member (collet) 22 for clamping the rod body 10 is provided at the end of the rod body holder 21. The clamping member 22 has an insertion hole into which the rod body 10 is inserted.

In this embodiment, the welding gun 20 includes a feeder 24, which is provided between the rod body holder 21 and the clamping member 22 and feeds the rod body 10, and a feeder shift mechanism 28.

In this welding gun 20, the rod body 10, which is formed of multiple fasteners 12 joined together, is held by the rod body holder 21 and is clamped by the clamping member 22, so that multiple fasteners 12 are always ready to be welded.

Next, a method of welding the fastener 12 using the fastener attaching device (welding gun) 20 according to the embodiment of the disclosure will be described in detail with reference to the drawings.

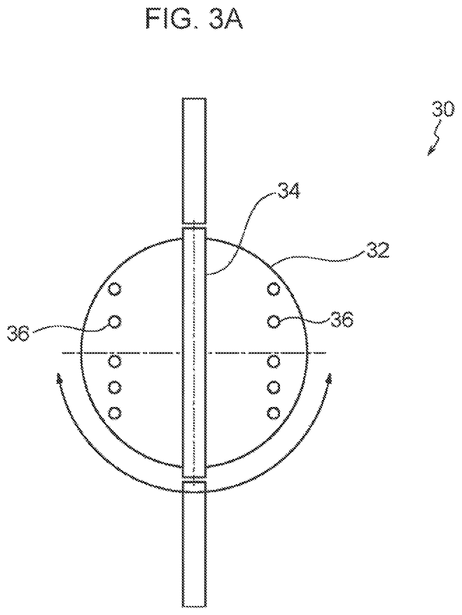

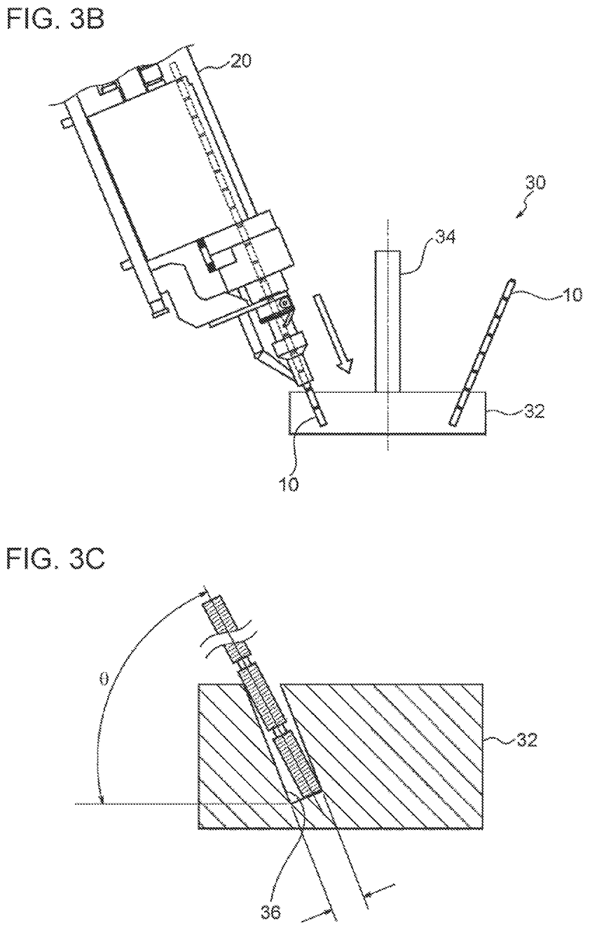

FIG. 3A is a plan view of a supply device 30 for the rod body 10. The supply device 30 is used in a rod body holding step, in which the rod body 10, serving as the fastener, is held by the rod body holder 21. The supply device 30 includes a turntable 32 having a substantially circular shape in plan view and a safety fence 34 erected at the center of the surface of the turntable 32 and extending in the diameter direction. The safety fence 34 defines a work area, in which the manipulator of the robot performs welding work, and the other area. A row of five holes 36 capable of accommodating ends of the rod bodies 10 are provided in the turntable 32, on each of the left and right sides of the safety fence 34, so as to be parallel thereto. The rod bodies 10 can be inserted into and accommodated in the holes 36 in advance. As will be described below, the rod bodies 10 accommodated in the turntable 32 are sequentially loaded into the rod body holder 21 and the clamping member 22 to be used. When all the rod bodies 10 located on the welding gun 20 side are used up in the welding operation, an operator can rotate the turntable 32 of the supply device 30 by 180° to supply new rod bodies 10 to the welding gun 20 side. Then, the operator can insert new rod bodies 10 into the empty holes 36 in the turntable 32 on the safety side.

FIG. 3B illustrates the operation of holding a rod body 10 accommodated in the turntable 32 with the welding gun 20. In FIG. 3B, the right side of the safety fence 34 is the safety side where the operator is present, and the left side of the safety fence 34 is the welding operation side where the robot is installed. The welding gun 20 is automatically controlled by the manipulator of the robot and operates such that a rod body 10 accommodated in a hole 36 in the turntable 32 is inserted from the opening at the end of the clamping member (collet) 22. The rod body 10 is held by the rod body holder 21 and, simultaneously, gripped by the clamping member 22. The inside diameter of the insertion hole of the clamping member 22 is slightly larger than the outside diameter of the rod body 10, and the rod body 10 inserted into the clamping member 22 is stably gripped by the clamping member 22.

FIG. 3C is a schematic enlarged view of the portion where the rod body 10 is accommodated in the hole 36 in the turntable 32, in FIG. 3B. The holes 36 in the turntable 32 are inclined at an angle θ<90° toward the side farther from the safety fence 34 on the turntable 32. The angle θ can be optimized by taking into consideration the postures of the manipulator of the robot and the welding gun 20 attached thereto. The inside diameter of the holes 36 is slightly larger than the outside diameter of the rod bodies 10. In this embodiment, the depth of the holes 36 is set to be approximately greater than or equal to the length of one fastener 12 and less than the length of two fasteners 12 of the rod body 10.

As illustrated in FIG. 3C, the rod body 10 is accommodated in the hole 36 so as to be in contact with and supported at two portions of the hole 36. One portion is on the inner side of the turntable 32, and the other portion is on the outer side of the turntable 32. Because the rod bodies 10 accommodated in the holes 36 are inclined at the same angle in the same direction, the welding gun 20 can easily hold the rod bodies 10 accommodated in the holes 36.

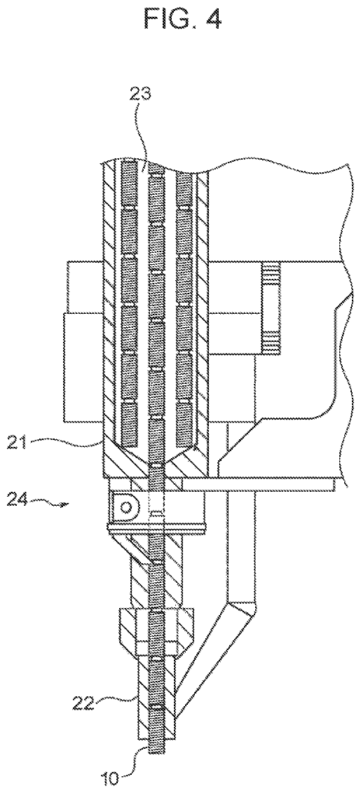

With the thus-configured turntable 32 illustrated in FIGS. 3A to 3C, the end of the clamping member (collet) 22 of the welding gun 20 cannot enter the hole 36 depending on the size thereof. Hence, the end of the rod body 10 inserted into and held by the clamping member (collet) 22 may protrude by an amount corresponding to a few fasteners 12. To accurately weld the fastener 12 at the end, it is desirable to adjust the length by which the end of the fastener 12 protrudes. In the welding gun 20 according to this embodiment, after the rod body 10 is inserted from the end of the clamping member 22, for example, the protruding end of the rod body 10 is pressed against the workpiece 40 such that the length by which the end of the rod body 10 protrudes is adjusted to be less than or equal to the length of one fastener 12, as illustrated in FIGS. 2 and 4.

This step of exposing the first fastener 12 by an appropriate length (head-exposing step) is performed by the operation of the manipulator of the robot when holding and gripping of the rod body 10 is performed with the configuration and operation illustrated in FIGS. 2 and 3. It is also possible that an operator manually performs the head-exposing step while ensuring safety.

FIG. 4 illustrates the configuration of the welding gun 20 according to another embodiment of the disclosure. The rod body holder 21 of the welding gun 20 has a rod body chamber 23 for accommodating multiple rod bodies 10. The bottom of the rod body chamber 23 is tapered in a bowl shape so that the next rod body 10 smoothly slides into the clamping member 22 when the previous rod body 10 is used. In this welding gun 20, a rod body loading port (not illustrated) is provided at the upper part of the rod body chamber 23, so that multiple rod bodies 10 can be loaded from this port and accommodated in the rod body chamber 23.

With the rod body holding step and the rod body clamping step using the rod body chamber 23, multiple rod bodies 10 can be accommodated in the rod body chamber 23. Thus, a longer, continuous attaching operation is possible.

Next, the head-exposing step in the case of holding the rod bodies 10 in the rod body chamber 23, as illustrated in FIG. 4, will be described.

The welding gun 20 has a mechanism for feeding the rod body 10 loaded or accommodated therein toward the end of the clamping member 22. A feeding operation will be described in detail below with reference to the drawings.

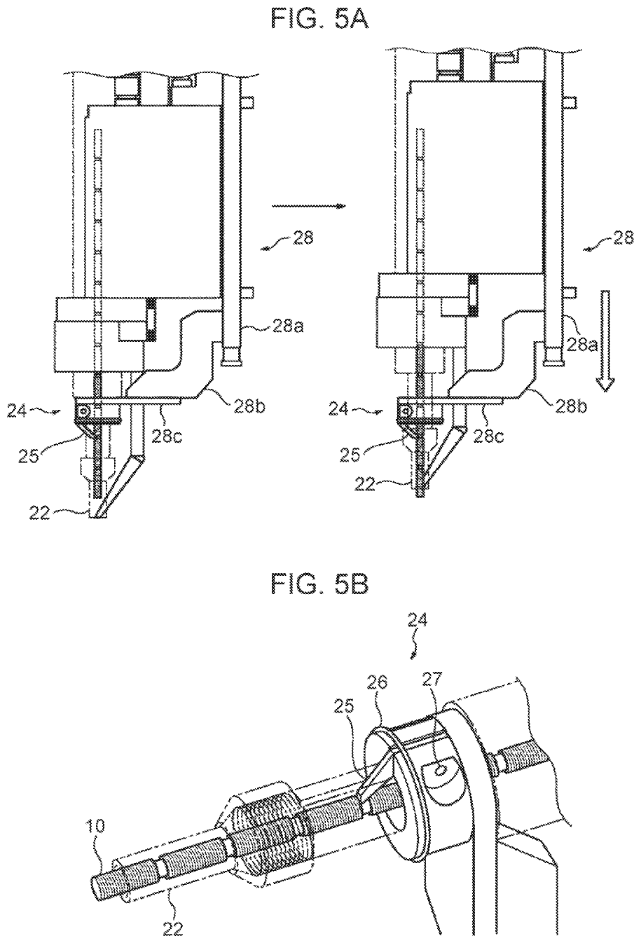

As illustrated in FIGS. 5A and 5B, the welding gun 20 according to this embodiment has a feeder 24 for feeding the rod body 10 to the end of the clamping member 22, and a feeder shift mechanism 28.

The feeder 24 according to this embodiment has an engaging claw 25 to be engaged with a fragile portion (small-diameter portion) 16 of the rod body 10. The engaging claw 25 is pivotable about an engaging claw pin 27. An elastic O-ring 26, serving as a spring for urging the tip of the engaging claw 25 toward the fragile portion 16, is provided on the outer side of the engaging claw 25. The feeder shift mechanism 28 moves the feeder 24 in the directions of the distal end and the proximal end of the clamping member 22. The feeder shift mechanism 28 is provided on the manipulator of the robot so as to be able to move the feeder 24, and includes a linear arm 28a, a curved arm 28b fixed to the linear arm 28a, and a joint member 28c for joining the curved arm 28b and the feeder 24. With this configuration, the feeder shift mechanism 28 can move the feeder 24 forward and backward (to the right and left in FIG. 5A).

The engaging claw 25 is engaged with the fragile part 16 of the rod body 10 and pushes the rod body 10 toward the tip of the welding gun 20 only when the feeder 24 is moved forward. When the feeder 24 is moved backward by the feeder shift mechanism 28, the engaging claw 25 pivots and moves without being engaged with the fragile part 16 of the rod body 10.

In FIG. 5A (left), the rod body 10 has advanced from the rod body chamber 23 toward the clamping member 22, but the end thereof does not project from the end of the clamping member (collet) 22. Hence, the head-exposing step to be ready for the operation of attaching the fasteners 12 is performed. As in FIG. 5A (right), by repeating the forward movement in the engaged state, i.e., moving (shifting) the feeder 24 toward the end of the welding gun 20 with the feeder shift mechanism 28 in a state in which the engaging claw 25 is engaged with the fragile portion 16 of the rod body 10, and the backward movement in the released state a certain number of times, the end of the rod body 10 is exposed.

This head-exposing operation with the feeder shift mechanism 28 may be performed in the welding gun 20 without the rod body chamber 23, as illustrated in FIG. 2, depending on the situation, such as when a rod body 10 broken and remaining in the welding gun 20 is fed to the end of the clamping member 22.

Next, in a welding step, the manipulator of the robot brings the fastener at the end of the rod body 10, the fastener being exposed at the end of the clamping member of the welding gun 20 fixed to the manipulator, toward a workpiece 40, or the workpiece 40 held by another robot is brought toward the end of the rod body 10 held by the clamping member 22 of the welding gun 20, and welding is performed by supplying current. For example, the process proceeds as follows:
1. The fastener 12 at the end of the rod body 10, which is exposed at the tip of the welding gun 20, and the workpiece 40 are brought into contact with each other.
2. A current is allowed to flow between the collet of the welding gun 20 and the workpiece 40.
3. When the fastener 12 at the end of the welding gun 20 is slightly lifted (separated) from the workpiece 40, an ultrahigh-temperature arc is generated between the workpiece 40 and the fastener 12, partially melting the workpiece 40 and the fastener 12 (generation of molten pools).
4. The supply of current is stopped, and the fastener 12 at the end of the welding gun 20 is pressed against the melted portion of the workpiece 40 and held until the molten pools are cooled and solidified by the room temperature. When the fastener 12 and the workpiece 40 are fixed, welding is completed.

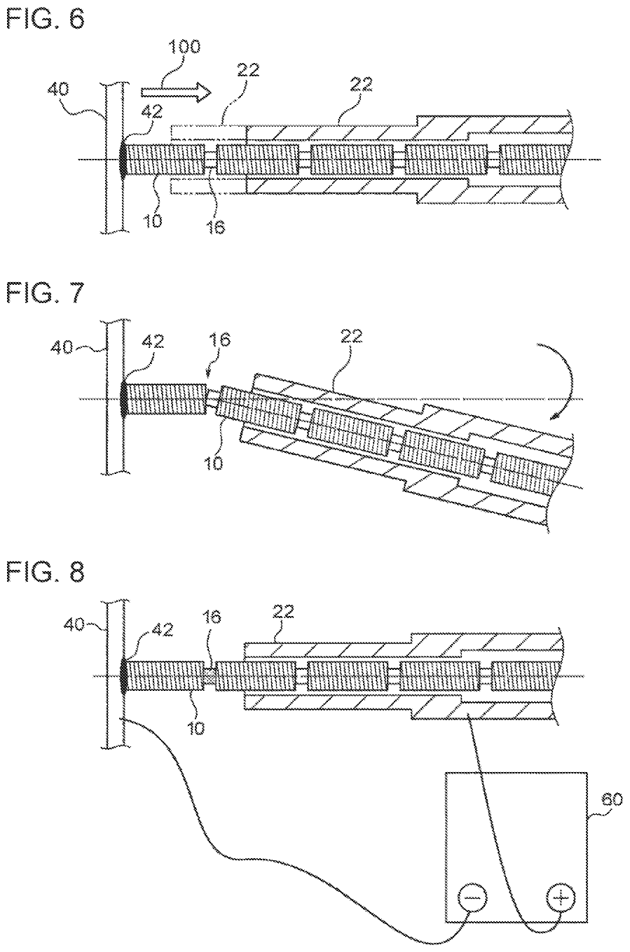

FIG. 6 illustrates a fragile portion exposing step after the welding step, in which the welding gun 20 is retracted by the operation of the manipulator of the robot. In a state in which the rod body 10 is welded at a welding point 42, the welding gun 20 is moved in the direction of an arrow 100 from the position of the end of the clamping member 22 of the welding gun 20 at the time of welding, which is indicated by a broken line, to the position indicated by a solid line. As a result, the tip of the next fastener 12, which is located immediately after the fastener 12 at the end of the rod body 10 welded to the workpiece 40, is exposed from the end of the clamping member 22, and thus, the fragile portion 16 between the fastener 12 at the end of the rod body 10 and the next fastener 12 is exposed from the clamping member 22.

FIG. 7 illustrates a separating step subsequent to the fragile portion exposing step. As illustrated in FIG. 7, in this embodiment, the manipulator of the robot is controlled by a program or the like so as to be tilted in a direction, such as left, right, top or bottom. As a result, a force is applied to the fragile portion 16 between the fastener 12 at the end of the rod body 10 and the next fastener 12, and the fragile portion 16 is dynamically cut.

FIG. 8 illustrates another example of the separating step. As illustrated in FIG. 8, a voltage is applied between the clamping member 22 and the workpiece 40 by a power source 60. This configuration does not need to be added, and the circuit configuration used for welding of the fastener 12 at the end may be used. By applying a predetermined voltage between the clamping member 22 and the workpiece 40 after the welding step, in which the fastener 12 at the end of the rod body 10 is welded to the workpiece 40, the fragile portion 16, which is a separation target point, between the fastener 12 at the end of the rod body 10 and the next fastener 12 is separated. The exposed fragile portion 16 has a smaller cross-sectional area than the other portions to which the voltage is applied. Hence, by applying a voltage, the fragile portion 16 is heated and thermally fuse-cut to be separated.

The operator determines which of the two separating steps is to be performed by considering the finish accuracy, the working environment, the time, the cost, and the like, and inputs an operation program to the robot in advance.

In the separating step according to this embodiment, the fasteners 12 are dynamically or thermally separated at the fragile portion 16 by the operation of the manipulator of the robot, without need of separating the fastener 12 at the end of the welded rod body 10 by using a special additional member. This makes the separating step smooth and quick. The robot having the welding gun 20 performs these steps a certain number of times on one workpiece 40 to complete the operation of attaching the fasteners 12.

With the fastener attaching method according to this embodiment, a fastener attaching operation utilizing the rod body 10 according to the embodiment of the disclosure is achieved by using the fastener attaching device 20 according to the embodiment of the disclosure. That is, the fasteners 12 are smoothly and sequentially welded to the workpiece from the fastener 12 at the end of the rod body 10.

Hence, a hose for individually delivering the fasteners 12 from the fastener delivery device to the fastener attaching device 20 is not used, and inconveniences, such as difficulty of welding work due to the presence of the hose and delivery failure caused by jamming of the fasteners 12 due to bending or twisting of the hose, are eliminated. Furthermore, there is no work associated with delivery through the hose.

Although the disclosure has been described in detail above, the disclosure is not limited to the configuration of the above-described embodiments, and various modifications can be made without departing from the technical idea, i.e., the gist of the disclosure, described in the claims, the specification, and the drawings.

For example, a chucking mechanism may be used as a mechanism for feeding the rod body 10. That is, feeding may be performed with a piston operation, in which a portion of the rod body 10 is clamped and pushed out by a chuck when the rod body 10 is fed, and the chuck is expanded to release the clamp when the feed mechanism is returned. This configuration does not use the engaging claw 25 when the rod body 10 is fed, and is suitable when the fragile portion 16 of the rod body 10 is not a small-diameter portion.

Instead of providing the welding gun 20 with the mechanism for feeding the rod body 10, the posture (the relative position and the relative angle of the welding gun 20 and the workpiece 40) in the welding operation may be devised to feed the rod body 10 to the end of the clamping member 22.

The disclosure provides a fastener, a fastener attaching method, and a fastener attaching device with which the fastener can be attached to a workpiece without any trouble in the fastener attaching operation.

1. A fastener apparatus to be welded to a workpiece by a fastener attaching device, the fastener apparatus comprising fasteners oriented in a same direction and joined together via a separable fragile portion to form a rod body.

2. A fastener attaching device fixed to a working end of a manipulator of a robot and configured to weld the fasteners formed as the rod body according to claim 1 to a workpiece by supplying current, the fastener attaching device comprising:
a rod body holder provided at an end and configured to accommodate and hold the rod body comprising the fasteners; and
a clamping member provided at an end of the rod body holder and configured to clamp the accommodated and held rod body from a periphery of the rod body.

3. A fastener attaching method using the fastener attaching device according to claim 2, the fastener attaching method comprising:
holding, with the rod body holder, the rod body comprising the fasteners;
clamping, with the clamping member, the rod body at an end of the rod body holder;
exposing an end of the fastener at the end of the clamped rod body;
welding one of the fasteners at the end to the workpiece by supplying the current;
exposing at least the fragile portion in a state in which the one of the fasteners at the end is attached; and
separating the rod body at the exposed fragile portion by operating the manipulator.

4. The fastener attaching method according to claim 3, wherein, in separating the rod body, the exposed fragile portion is cut by applying a force to the fragile portion by operating the manipulator of the robot to which the fastener attaching device is fixed.

5. The fastener attaching method according to claim 3, wherein, in separating the rod body, the exposed fragile portion is fuse-cut by allowing the current to flow between the one of the fasteners attached at the end and the clamping member clamping the rod body.
